(19) United States
(12) Patent Application Publication
(10) Pub. No.: US 2004/0027593 A1
(43) Pub. Date: Feb. 12, 2004

(54) Techniques for resolution independent rendering of images

(76) Inventor: David Wilkins, Providence, RI (US)

Correspondence Address: JAMES L DAVISON, 19822 226TH AVENUE N.E., WOODINVILLE, WA, 98072

(21) Appl. No.: 10/399,222

(22) PCT Filed: Oct. 12, 2001
(86) PCT No.: PCT/US01/42694

(51) Int. Cl. G06K 15/02; G06T 3/40; H04N 1/393

(52) U.S. Cl. 358/1.2; 382/299

(57) ABSTRACT

A method to improve the performance of rendering image data (402) by converting what would normally be considered resolution-dependent image behavior into behavior that is substantially resolution-independent. This allows significant performance improvement since the rendering (454) can be performed on the lower-resolution image data used, for example, for on-screen viewing and when the image effect is applied to a higher resolution rendering, the effect, as viewed, is substantially the same as the effect viewed at a lower resolution. This conversion of normally resolution-dependent behaviors into pseudo-resolution-independent behaviors also allows the image effects to be applied to be carried out on a lower resolution image with confidence that when the image is rendered at a higher resolution that the image effects applied will substantially have the same appearance that the effect had at the lower resolution.

This application is entitled to the benefit of Provisional Patent Application Serial No. 60/240,495 filed Oct. 13, 2000.

### BACKGROUND OF THE INVENTION

1. Field of Invention

The present invention relates generally to digital image processing systems. More particularly the invention describes techniques that greatly improve the performance of rendering image data. More particularly, techniques are described that take advantage of resolution-independent characteristics, even for operations that are traditionally not considered to be resolution-independent. More specifically, certain techniques are applied to simulate resolution-independent behavior (called pseudo-resolution-independent) when an image operation is applied at any resolution.

These techniques can greatly improve the performance of rendering systems in computer applications, such as those executing on personal computers, digital imaging consumer appliance devices, and when viewing and manipulating photos over a network environment (in the form of client-side or the server-side executable code on either a physically wired or wireless medium).

Most image operations fall into two categories: those that generate the same result, regardless of the resolution of the image (i.e. resolution-independent) and those that generate significantly different visible results for different resolutions of image data (i.e. resolution-dependent). Rotation, for example, is invariant across all resolutions and is resolution-independent However, a special effects image processing operation such as a Fresco paint effect varies widely across different resolutions and is resolution-dependent.

If only resolution-independent operations are supported, a significant performance improvement is achieved since rendering can be performed on the lower-resolution image data that is needed for on-screen viewing of the output. Because, in general, the resolution of the display is usually much less than that of most other output devices, such as a high-resolution printer.

If all, or at least the majority, of the resolution-dependent image operations behave in such a way that they simulate resolution-independent behavior, most of the benefits of resolution-independence are still realized. While it may not be possible to support a continuous range of resolutions in a resolution-independent manner, certain assumptions and constraints are made that allows resolution-independence to be approximated, thus creating a new class of pseudo-resolution-independent image operations. In the preferred embodiment, all operations are either resolution-independent or pseudo-resolution-independent.

One of the objects of this invention is the ability to efficiently process image data at lower-resolutions, but then also be able to obtain consistent results across all resolutions. This is particularly important when viewing and processing images in on-screen display devices, since in general these devices are much lower resolution than the resolution of the image data. Moreover, this invention provides this efficiency without sacrificing consistent results across all resolution, something most applications today cannot correctly support.

Another object of the invention is to be able to process and transmit must less image data than would otherwise be necessary, which is essential in a network-connected environment. If the client must download image data, where it is processed locally (on the client), it is of much benefit to only require that a small amount of data be downloaded. Today, the original resolution image must be transferred to the local client so that the image operations can achieve consistent results even though a small screen resolution view (less than the original resolution image) is needed. Even when the operations are performed on the server, the ability to perform the image operations at the screen resolution of the image data significantly reduces the processing and memory requirements of the server, thus permitting many more transactions to be performed in the same amount of time.

An equally important benefit is that these techniques allow digital imaging operations to be performed on low-cost consumer electronics imaging devices that have low-processing power and little memory. Up until now, this has been difficult to achieve due to the system constraints.

2. Description of Relevant Art

Traditional image processing applications, such as Adobe Photoshop™, assume that the best way to get consistent results for all image processing operations is to perform the operations at the original image resolution, regardless of the targeted output device's resolution (whether it is higher or lower than the original image resolution). This guarantees consistent results, regardless if the image is viewed on a low-resolution video display or a high-resolution printer. Traditional image processing applications usually support one of two approaches listed below:

The first approach, shown in FIG. 1a, accumulates the sequence of image operations that are applied and re-renders each operation when an updated output image is requested from the output device. This involves the complete reprocessing of all image operations at the image's original resolution. This can be a very slow process since each operation is reapplied at the original image resolution. This gives the user the flexibility to have unlimited undo capabilities since each operation is stored in a list of operations.

Referring now to FIG. 1a, process 100 is a flowchart that details the processing of a digital image using a traditional image-editing model. Process 100 begins at 102 when a particular digital image is opened by the application at the resolution of the image. There is no resampling/rescaling that occurs. At 104, a determination is made if any image editing operations should be performed. If no image operations are to be performed, control is pass to 108. Otherwise, at 106 the image operation is performed on the original image resolution data, then control is passed back to 104, where it is determined if there are additional image operations to be processed. It should be noted, in this model successive image operation are applied on top of (or accumulated on) the previous image operations that have been applied to the image.

At 108, the desired output resolution is determined. At 110, if the original image resolution does not match the desired output resolution, then at 112 the image is copied into a temporary buffer and is resized to match the desired output resolution and then control is passed to 114. Otherwise, control is passed directly to 114 where the image is sent to the output device. When the output device selected is a display, the output resolution may vary depending if the image is enlarged or reduced (zoomed in/out) on the display. However, the key observation is that the image operations are generally applied to the original image resolution data, and after all operations are applied, the image is resized to match the resolution of the output device.

The second approach, shown in FIG. 1b, performs each operation on the image data at the original image resolution, but in an intermediate working or cached buffer. This working buffer contains the entire image at the original image resolution. As each new operation is applied, it is performed directly on the working buffer. When a desired output resolution image is to be generated, the working buffer is resampled to match the desired output resolution. Clearly, the benefit is that each operation is normally applied once in the working buffer and does not need to be reprocessed when a new output resolution is requested. The disadvantage with this approach is that while unlimited undo/redo operations are possible, it is more difficult to support such a feature since the entire list of image operations are not normally re-rendered when an updated output image is requested.

Referring now to FIG. 1b, a process 150 is a flowchart that details the processing of a digital image using this model. The process 150 begins at 152 when a particular digital image is opened by the application. At 154, the digital image is copied into the working buffer, at the same resolution as the original. At 156, a determination is made if any image editing operations should be performed. If no image operations are to be performed, control is pass to 160. Otherwise, at 158 the image operation is performed on the working buffer (with the accumulated operations), then control is passed back to 156, where it is determined if there are additional image operations to be processed.

At 160, the desired output resolution is determined. At 162, if the resolution of the working buffer (which is the resolution of the original image) does not match the desired output resolution, then at 164 the working image is copied into a temporary buffer and is resized to match the desired output resolution. In either case, at 166 the resized image from the temporary buffer is displayed on the output device. The process then waits at 168 until either a request to re-render the image or a user request for a new image operation is applied. At 170, it is determined if the program should terminate, if so the appropriate steps are taken and the process stops. Otherwise, control is pass back to 156 to process the request. In this way, the entire list of image operations need not be reapplied to the working image buffer.

The approach taken by Adobe Photoshop™ is a combination of the two approaches. In this case, an intermediate working buffer (s) is used, but is considered a cache that can be flushed if the user performs an undo operation. The working buffer can be discarded and be regenerated based on the updated list of image operations. Alternatively, the working buffer can be reverted to a previous cached copy of the working buffer. Taken to an extreme, all intermediate operations can be cached, simulating the effect of infinite undo/redo operations. This is at the expense of using a significant amount of memory and/or disk space

While each of these approaches has the benefit of providing consistent results across all resolutions, it is generally slower since the image processing operation(s) must be performed on all the pixels at the original image resolution. Although using intermediate working buffer caches minimizes the need to reprocess all image operations each time a new render resolution is requested, the image operation(s) must still be performed on the original resolution the first time. Even on the fastest processors today, this can still be a time consuming operation. It should be noted that variants of this model are possible when certain common resolution-independent operations are performed, such as rotate or color adjustment filters. In these situations, it is common to resize/resample the working buffer to a much lower resolution, such as the screen resolution, where a preview of the operation can be shown. Using this technique, real-time manipulation is feasible for the limited set of resolution-independent operations. Once the user is satisfied with the results, the operation is then applied to the original resolution working image buffer.

While this does mitigate some of the disadvantages described above, only a small subset of image operations conform to this resolution-independent behavior or can support the desired real-time manipulation functionality.

More recently, new technology is available that allows efficient image rendering when all image operations are performed in a resolution-independent manner. An imaging application that supports FlashPix™ technology, developed by a consortium of companies comprising of the Digital Imaging Group (DIG), can display and manipulate on-screen images at a lower-resolution in a consistent manner, but retains the ability to process higher-resolution image data.

FlashPix™ technology defines a limited set of image operations including: rotation, translation, cropping, color twist, blur/sharpen adjustment, and brightness/contrast adjustment. Each of these operations is defined such that they can be performed at specific “powers of two” resolutions as defined by the FlashPix™ standard, but provides consistent results across all these resolutions.

Referring now to FIG. 2, process 200 is a flowchart that details the processing of a digital image using the FlashPix™ imaging model. The process 200 begins at 202 when a particular digital image is opened by the application. At 204, the desired output resolution is determined. At 205, it is determined if the output resolution and the original image resolution are the same. If they are not, at 206, the image is resized to match the resolution of the output device. In either case, at 208, a determination is made if any image editing operations should be performed. If no image operations are to be performed, control is pass to 212. Otherwise, at 210 the image operation is performed on the image data resized in step 206. Control is then passed back to 208, where it is determined if there is additional image operations to be performed.

At 212, the processed image is sent to the output display device. Since at 204 the output resolution was already determined and all processing was performed on the targeted output resolution, no additional resampling of the image is needed. It should be noted, a similar working buffer cache could also be employed in the FlashPix™ rendering model, as described in section 2.1 above.

The FlashPix™ imaging model provides the benefit of quick and efficient processing of the image operations when performed on lower-resolution image data. This provides for real-time manipulation and rendering on a low-resolution output display device. While this is clearly beneficial, only a small set of resolution-independent operations are actually supported. More particularly, it would be impossible to support any operation that is resolution-dependent, or even pseudo-resolution-independent since the architecture does not permit for such provisions as described in this paper. It is also noted that FlashPix™ only supports specific “powers of two” resolutions, and not a continuous range of resolutions as provided by this invention.

A completely opposite and simplistic approach is also used in which the resolution requirements of the image operations are ignored and each operation is processed at some fixed resolution. This resolution usually does not match the original image resolution, nor does it provide for consistent behavior if the operations were applied at different resolutions. For the cases when the image operations are resolution-independent, as for those supported by Flashpix™, this model works and provides consistent results. However, for those cases where the image operations are not resolution-independent, more inconsistent results are seen. The degree of inconsistency is a function of the specific image operation.

For example, when applying a resolution-dependent blur operation, such as a low-pass 5×5 kernel, the amount of blur becomes less pronounced as the resolution (and image size) increases. This may not be too objectionable since in both cases, the image appears with some degree of blurriness. However, for a “ripple” effect, in which a simulation of a ripple of a stone dropping into a lake is rendered onto an image, the actual number of concentric ripples and appearance varies depending on the resolution and the exact characteristics of the algorithm (see sample output for the ripple operation in section 5.2 and 5.3).

Referring now to FIG. 3, process 300 is a flowchart that details the processing of a digital image using this approach. The process 300 begins at 302 when a particular digital image is opened by the application. At 304, the desired output resolution is determined. At 305, it is determined if the output resolution and the original image resolution are the same. If they are not, at 306, the image is resized to match the resolution of the output device. In either case, at 308, a determination is made if any image editing operations should be performed. If no image operations are to be performed, control is pass to 312. Otherwise, at 310 the image operation is performed on the image data resized in step 306. This occurs even though the image operation may require the original image resolution data; therefore, proper results might not be obtained. Control is then passed back to 308, where it is determined if additional image operations are to be performed.

At 312, the processed image is sent to the output display device. Since at 304 the output resolution was already determined and all processing was performed on the targeted output resolution, no additional resampling of the image is needed. It should be noted, a similar working buffer cache could also be employed in this rendering model, as described in section 2.1.

It is common for this type of approach to be taken on Web sites that support image processing operations, but where the primary output target is a low-resolution output display device. In general, after the image operation is applied to the image (at low-resolution), the results are commonly e-mailed to a recipient. The recipient then views the low-resolution result (already rasterized) on their low-resolution output display device.

For cases when the operation is reapplied to the original resolution image data for printing, such as through an on-line print fulfillment service, the situation is even more problematic. The user may preview the output via a low-resolution rendered image on-screen. In this case, the output viewed on the display may not match the final printed output that is ordered.

Even if 80% of the time this discrepancy is not detected, for those that do notice the difference, they may request a refund of a printed output. This situation is very costly and is clearly not an acceptable solution. This invention creates a more desirable result since consistency is achieved across all resolutions for all operations, thus improving customer satisfaction.

More importantly, a photo service that takes the “ignore it” approach will most likely limit the supported image operations to minimize this problem. What is desired is the ability to offer a larger range of image operations, assuming these image operations are either resolution-independent or are structured that they can take advantage of resolution independent characteristics (i.e. pseudo-resolution-independent).

### SUMMARY OF THE INVENTION

In summary, the present invention consists of a method for applying normally resolution-dependent image effects in such a manner that the effects have substantially the same appearance regardless of the final resolution of the image. This allows the effects to be applied to any image resolution with the confidence that regardless of the later resolution rendered, the resulting effect will have the same appearance as it had when it was applied to the original resolution. By determining which particular effect parameters are resolution dependent and then modifying those parameters with the modification values being predicated on the final image resolution being rendered, it is possible to convert resolution-dependent parameters into substantially resolution-independent parameters.

### BRIEF DESCRIPTION OF THE DRAWINGS

The invention, together with further advantages thereof, may be best understood by reference to the following description taken in conjunction with the accompanying drawings in which:

FIGS. 1a and 1b show a flowchart that details two traditional methods of image processing.

FIG. 2 shows how FlashPix™ processes a digital image.

FIG. 3 shows how a digital image may be processed at a fixed resolution.

FIG. 4 and 4a are flowcharts that show how the present invention renders a resolution dependent image.

FIG. 5 shows the details for selecting the best resolution for a series of image operations that are to be processed.

FIG. 6 shows an implementation for handling the “DoAnalyze” phase of the present invention.

FIG. 7 shows the process for selecting the best resolution for the image to be processed based on the original resolution and the current output resolution.

FIG. 8 shows a digital image at different resolutions.

FIG. 9 shows a filter used to make the ripple effect applied to one resolution suitable for any resolution.

FIG. 10 shows the result of not applying a compensating filter action to the ripple effect.

FIG. 11 shows a filter used to render the tiles image effectively resolution independent.

FIG. 12 shows the tiles at different resolutions without the compensating filter action.

FIG. 13 shows a Fresco effect using a compensating resolution filter.

FIG. 14 shows the same Fresco effect without the compensating filter action.

FIG. 15 shows a side-by-side comparison of using a compensating filter action and not using the filter action on a chalk/charcoal image effect.

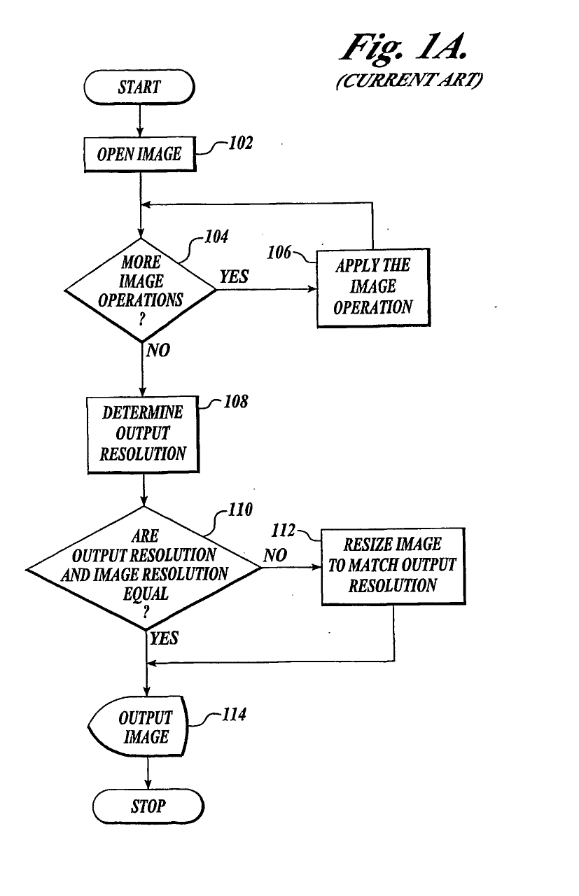

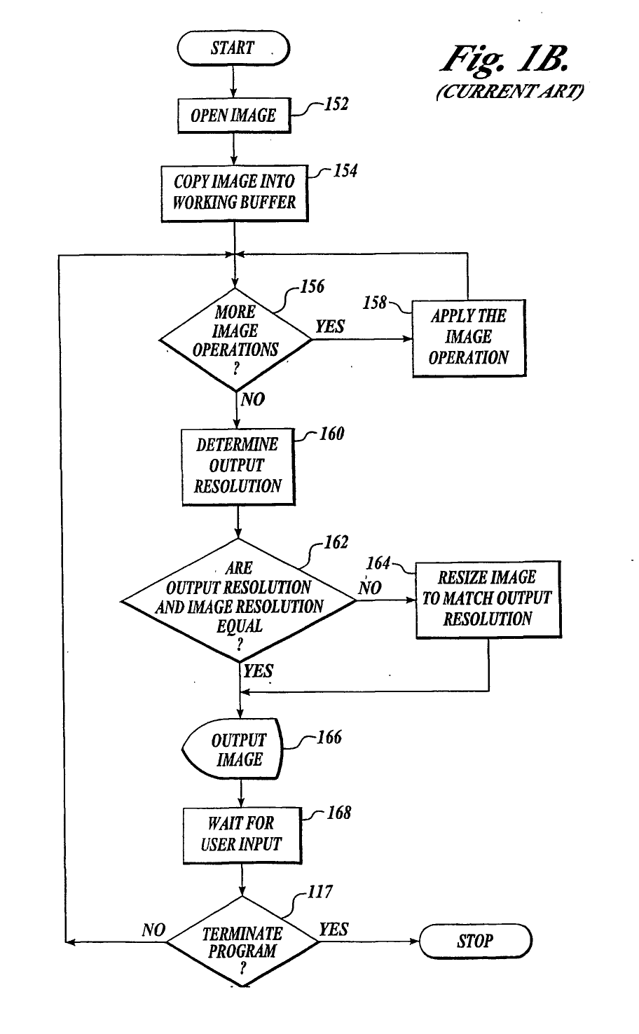

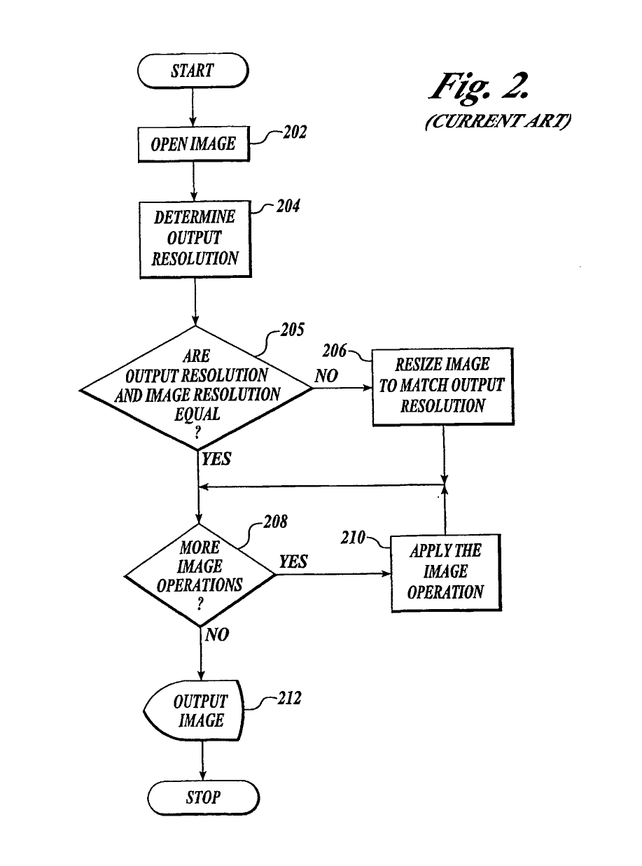

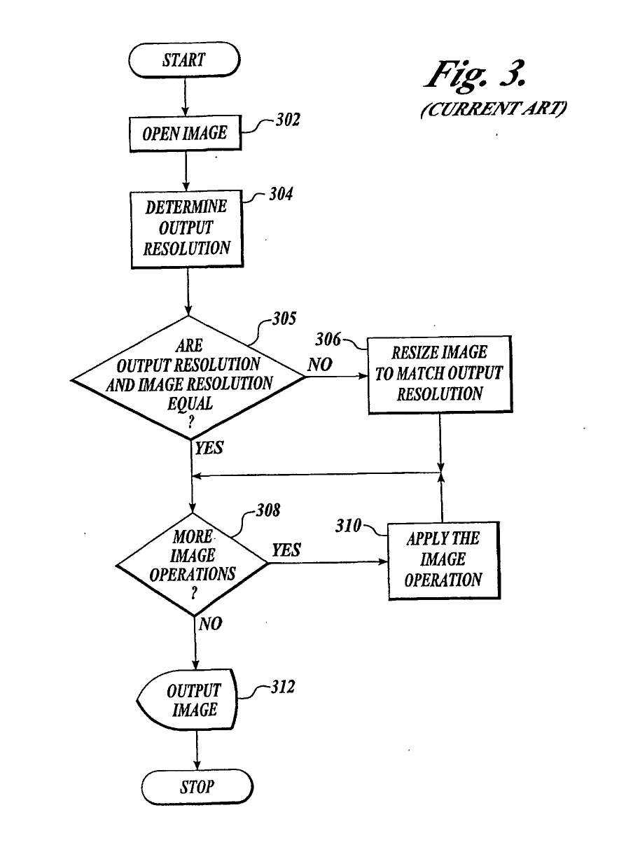

### DETAILED DESCRIPTION OF THE EMBODIMENTS

The present invention was originally targeted for deployment on image processing servers, as part of an ASP (Application Service Provider) model that are deployed on systems handling between hundreds to thousands of simultaneous operations at one time. What is desired is a solution that is scalable across many computers. More importantly, it provides consistent results across all image resolutions regardless of the size of the image rendered, but with a decrease in rendering time as the output resolution decreases.

It should be noted that image data could range from between low-resolution (such as 320×240) images up through several mega-pixels images (such as 3000×3000 pixels). Significant performance improvements are realized if a model is developed that permits rendering of these huge images, but performed on low-resolution image data (such as 320×240). This provides not only quick display of images, but also reduces the amount of image data that must be transferred between data storage servers (where image data resides), image processing servers (where the image processing code renders the operations) and the client systems (where the output may be viewed).

This provides several benefits. First, the amount of processing power for each operation is significantly reduced since only a small amount of image data is actually processed. More importantly, in a network environment, only the low-resolution image data must be transmitted between server(s) and the remote client computer. This is particularly important when executing in a low-bandwidth (i.e. 56 Kb modem) environment.

Another benefit realized by this invention is that when processing either resolution-independent or pseudo-resolution-independent image operations, the original image resolution does not have to be accessed, nor must it even be available. In some situations, the original image resolution is not available and may only be available when required for generation of high-resolution printed output. In this case, most of the processing must occur at a lower-resolution, either on the server computer on the client/host computer. This invention provides a solution that results in consistent output even though the original image resolution may not be available. Without this, it would not be possible to guarantee consistent behavior except for resolution-independent image operations.

The processing of lower-resolutions images result in the need of less processing power and lower memory requirements, both of which are critical when developing low-cost consumer electronics digital image devices, including an information appliance, a digital camera, a digital camcorder, a digital television, a digital photo scanner, photo-enabled set-top box, a photo enabled game machine, a photo enabled internet device, cell phone, cable set-top box, WebTV™ or any other computing device that can view images.

Image operations that fall into the Resolution-independent category involve those that yield consistent results across all resolutions. For example, for image A, an imaging operation is applied to an image at a particular resolution and then the image is resized to a smaller resolution. For image B, the image is first resized to the smaller resolution and then the image operation is applied. If image A and image B are sufficiently visually close, taking into account the errors introduced during the resampling/resize operation, the operation is considered resolution-independent. Put another way, when the user views image A and image B side by side, they should visually appear the same.

Some of the following operations that fall into this category including rotation, cropping, translation, color adjustment, color twist, brightness/contrast adjustment (not based on an image's histogram), blur and sharpen operations (as defined by the FlashPix™ imaging model), Duotones (convert the image into a two tone color image), grayscale/black&white, negative, solarize, posterize (reduction in the number of colors), and bi-level/threshold. This is by no means a comprehensive list, but is illustrative of the type of operations that are considered resolution-independent. It should be noted, the FlashPix™ imaging model only supports a small subset of these operations.

There are several classes of pseudo-resolution-independent image processing operations. As additional resolution-dependent image operations are investigated to determine how they can simulate resolution-independent behavior, new classes of pseudo-resolution-independent operations will be created.

Histogram Based Image Operations

This class of image operations modifies a given pixel value based a transform function from the histogram of the image. For example, an auto-enhancement function may look at the histogram and cut off 5% from each end of the histogram and redistribute the histogram across the entire range.

Since the histogram of the original resolution image is close to the histogram of a lower-resolution image this could possibly be considered resolution independent. However while this is generally correct, the assumption breaks down as the resolution becomes very small (such as a 192×192 thumbnail). Therefore, what is desired is an approach that provides true resolution-independence, but without requiring processing of original resolution pixel data each time the image is rendered.

This invention solves this problem by performing the image operation in multiple phases. The Analyze phase is first performed on the image data. This phase processes all the pixel data, ideally at the original image resolution, so that a histogram can be computed. During this phase, the pixels are not modified. Once the histogram is collected, appropriate image operation parameters can be ascertained, such as how the histogram should be redistributed. During the second phase, the Filter phase, the image data is actually modified. The benefit of this approach is that the parameters are resolution-independent and thus, the Filter phase can actually be performed at any resolution, lower or higher than that of the original resolution of the image data.

By performing an Analyze phase on the original image data's resolution and storing those results for future renderings, the Filter phase can be performed at any resolution. This technique simulates resolution-independent behavior across all resolutions.

General Analyze Phase/Filter Phase Utilization

The class of image operations described above is a subset of this category. While the Analyze/Filter phase model is described above in terms of usage for histogram filter operations, it can be used in a more general manner. For example, red-eye reduction and adjust artificial lighting are two image operations that are normally considered resolution-dependent, but can simulate resolution-independence by allowing an Analyze phase to initially be performed at the original image resolution.

The Red-eye reduction filter operation is separable into two pieces: (a) detection of the red-eye and (b) removal/cleanup of the affected area. In order to accurately detect the red-eye in the first place, it is desirable to perform the detection at the original image resolution. Otherwise, a subsampled image may sufficiently blur the area of the eye so that it cannot be accurately detected. Further, if processing occurred on a very low-resolution image, such as a 320×240 screen nail image, it most likely would not be possible to even visually see the red-eye.

Once the detection is performed at the original image resolution, the coordinate and radius of the red-eye is preserved in resolution-independent coordinates. With both the coordinate and radius, it is then possible to remove/cleanup the red-eye at any resolution. If cleanup were applied at a very low-resolution, such as a 320×240 screen nail, the cleanup region would be small. On the other hand, if performed on a very higher-resolution image, the cleanup region would be larger, centered about the coordinate of the red-eye.

The artificial lighting adjustment filter is also an operation that requires this two-phased approach. The first pass is performed to determine how much of a particular light (such as yellow for incandescent lighting) exists in a photo. If more than a certain percentage (i.e. 25% of the photo) contains the particular color range, the image is corrected. Since the determination is based on this fixed percentage, the exact amount may vary slightly depending on the resolution. For example, if exactly 25% of the image contains yellow at the original image resolution. When the image is downsampled, the percentage calculated will usually be slightly below or above 25%.

For consistency across all resolutions, the detection of the color is performed at the original image resolution and stored during the Analyze phase. When rendering occurs, the Filter phase is performed at any resolution, but based on the data collected from the original image resolution data during the Analyze phase. By performing an Analyze phase on the original image data's resolution and storing those results for future renderings, the Filter phase can be performed at any resolution. This technique simulates resolution-independent behavior across all resolutions.

Modification of Internal Parameters

The third class of pseudo-resolution-independent image operations modify internal parameter values, usually based on some constant value or range of values that becomes a function of the resolution of the image.

For example, the ripple filter simulates the effect of dropping a pebble into the pond rendered onto a photo. Most algorithms perform this by simulating a mathematical wave function across the image. In general though, this is dependent upon the size of the image. Therefore, a different number of ripples are seen on different resolutions of the same image.

An alternative approach is having the mathematical wave function that takes as a parameter the resolution of the image such that different resolutions will look similar. (i.e. have the same number of ripples) This is sometimes possible by scaling a parameter, based on the resolution, either linearly or by determining some logarithmic or geometric function to perform the scale.

Multiple Discrete Resolutions

The fourth class of pseudo-resolution-independent image operations selects different discrete internal parameter values for different resolutions. For these image operations, it is generally not possible to define a mathematical function for each internal parameter.

It is possible to simulate resolution-independent behavior by choosing discrete parameter settings for images at different resolutions, so that it is approximated across all resolutions. First, the maximum side of an image is determined. Next, the maximum side is compared to each of the available resolutions. The one that most closely matches is chosen.

Paint Effects are a set of image operations that simulate various artistic effects, such as Chalk/Charcoal or Fresco art effect. For these operations, supported sizes might include: 128, 256, 512, 1024, 2048, and 4086. For images less than 128, the settings associated with 128 are used. There is nothing special about how these numbers are selected. Another image operation may choose to support the following sizes: 200,400,800,1600, and 3200. For any given image operation, a specific set of fixed resolutions is supported.

When an image is rendered that does not have an exact match to the supported size, two approaches are currently used. The most common approach is to choose the parameter settings closest to size of the image being rendered. This approach provides consistent results across all resolutions for many image operations in this class.

An alternative approach is to resize the image to match the correct intermediate size supported by the image operation. In some situations, this results in more consistent rendering across different resolutions, assuming the exact supported resolution of the image operation does not match the desired output resolution. After the operation is applied, the image may need to be resized back to the desired output resolution. If some or all of the image operations support the same size, this may be the more desirable approach since only one resample of the image is needed. Unfortunately, this does produce the negative effect introduced by the additional resampling operation.

Resolution-Dependent Operations

Image operations that fall into this category are by definition not resolution-independent. More importantly, these operations cannot approximate resolution-independence as described in the pseudo-resolution-independent section above.

The goal is to minimize the number of resolution-dependent image operations that are supported, or alternatively not support any resolution-dependent operation. In the past this was not viable since it would result in an application supporting very few imaging operations. By being able to simulate resolution-independence (i.e. psuedo-resolution-independence) at continuous or discrete sets of resolutions, it is now feasible for an application to simply not support resolution-dependent operations as a viable option.

Rendering Implementation Details

In the best mode the rendering pipeline takes into account the characteristics of each of the above image operations, in order to determine how to render each of the image operations in the most efficient manner. These characteristics determine if the image operation is resolution independent, pseudo-resolution-independent, or neither (i.e. resolution-dependent). Further, the relationship between various image operations must be defined since each operation may interact with the others. For example, the application of a Chalk/Charcoal paint effect followed by a rotate result in a different outcome compared to if the rotation were applied prior to the application of the paint effect.

If all operations are resolution-independent, the rendering pipeline is very similar to what is defined by the FlashPix™ image model. In this case, the relationship between the various image operations must still be specified, but all operations can occur on the same resolution. More importantly, all can be performed on low-resolution image data thus requiring less processing power and memory.

Where the benefit of this invention becomes more apparent is when one or more of the image processing operations includes a pseudo-resolution-independent image operation. In this case, rendering may be required at some predetermined resolution, close to the desired output resolution, but does not require the image data at the original resolution to be accessed or rendered.

Base Pipeline Implementation for this Invention

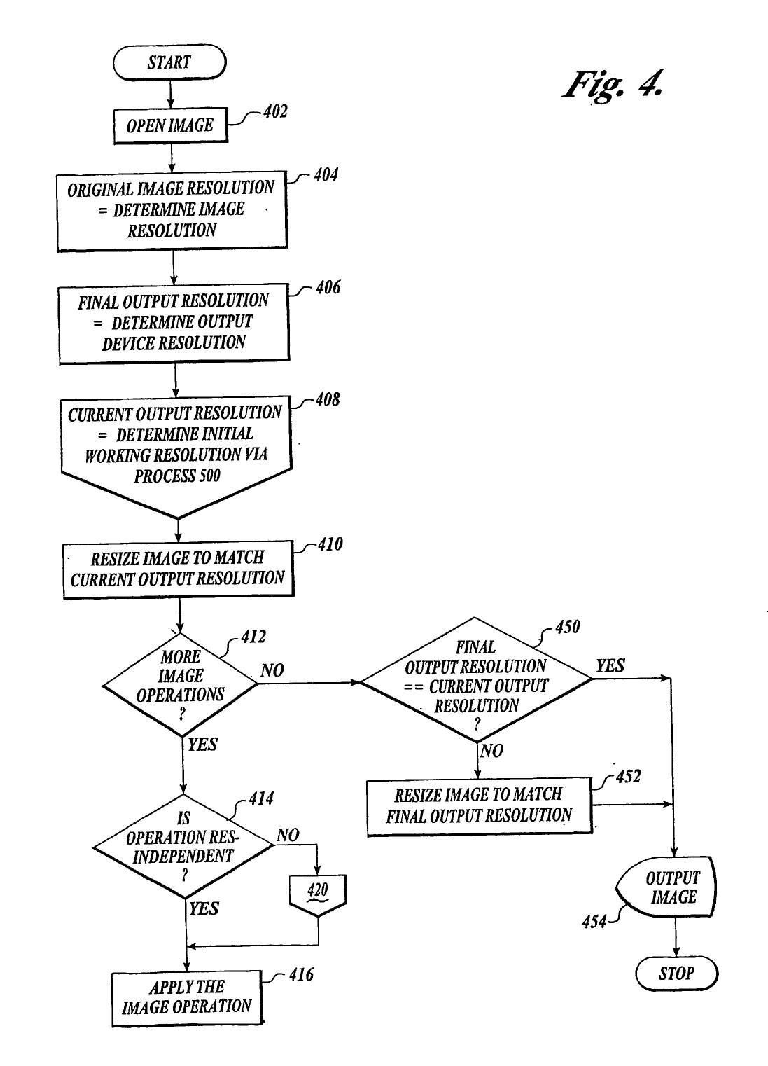

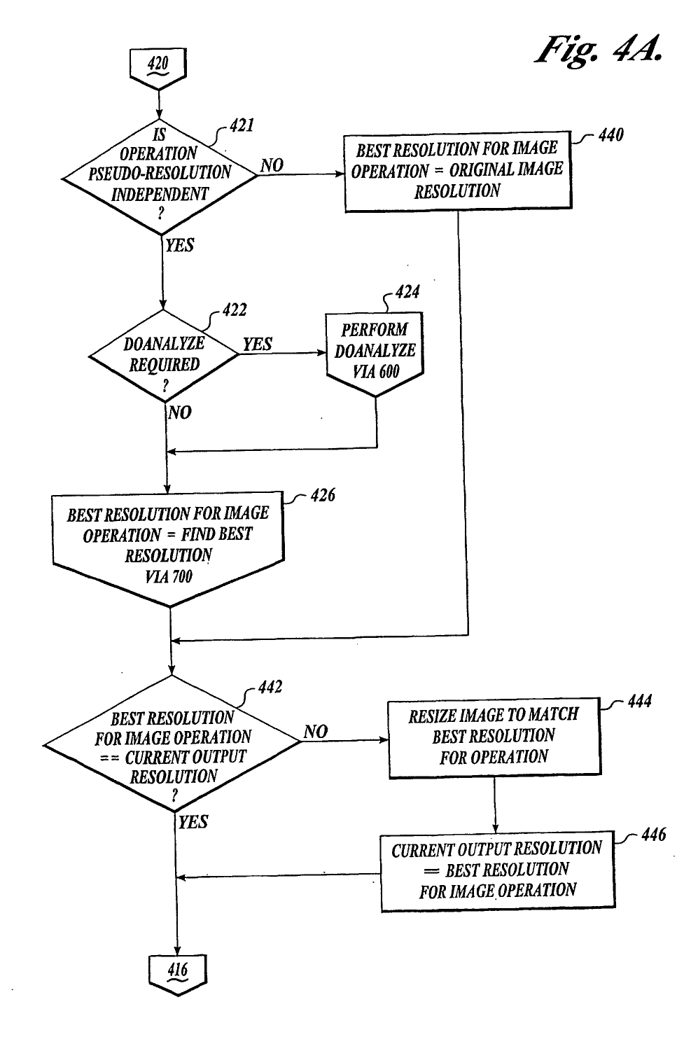

Now referring to FIG. 4, a flowchart is shown detailing the process for rendering the image as defined by this invention. The process 400 begins at 402 when a particular digital image is opened by the application. At 404, the resolution of the digital image is determined and recorded in originalImageResolution. At 406, the resolution of the output device is determined and the variable finalOutputResolution is set to this value.

At 408, it is determined, via process 500, what the initial working resolution should be and currentOutputResolution is set to this value. At 410, the image is copied to an appropriate buffer and is resized to match the resolution specified in 408 and control is passed to 412.

At 412, a determination is made if any image editing operations should be performed. If no image operations are to be performed, control is pass to 450. Otherwise, at 414 it is determined if the image operation is a resolution-independent operation. If it is not a resolution-independent operation, control is passed to 420 (FIG. 4a). Otherwise, control is passed to 416 where the image operation is performed at the currentOutputResolution. Control is then passed back to 412.

At 420 (FIG. 4a), it is determined if the operation is pseudo-resolution-independent If it is, control is passed to 422. Otherwise, control is passed to 440 since it is a resolution-dependent operation. At 440, the bestResolutionForImageOperation is set to originalImageResolution, since it is a resolution-dependent operation. Control is then passed to 442

At 422, it is a pseudo-resolution-independent operation. There it is determined if a DoAnalyze phase is required. If it is required, then at 424 the DoAnalyze phase is handled, via process 600 after which control is passed to 426. If no DoAnalyze phase is required, control is passed directly to 426 where it is determined, via process 700, what the closest supported resolution for this pseudo-resolution-independent image operation is and sets bestResolutionForImageOperation to this value. Control is then passed to 442.

At 442, if the bestResolutionForImageOperation matches currentOutputResolution, control is then returned to 416 (FIG. 4) where the image operation is performed on the image. If the resolutions do not match, control is passed to 444 where the image is resized to match the bestResolutionForImageOperation. At 446, the currentOutputResolution is set to the bestResolutionForImageOperation. Control is then returned to 416 (FIG. 4) where the image operation is performed on the image.

At 450 (FIG. 4), all image operations have been performed and the values currentOutputResolution and finalOutputResolution are compared. If these are equal, control is passed to 454 where the processed image is sent to the output display device. Otherwise, control is passed to 452 where the image is resized/resampled to match the finalOutputResolution. Control is then passed to 454 where the processed image is sent to the output display device.

It is clear from the flowchart that if all image operations are resolution-independent, and can be performed at any resolution, then all operations are performed at the finalOutputResolution. However, when an image operation is resolution-dependent, it must be performed at the original resolution of the image (originalImageResolution). After all image operations have been performed, the image must then be rescaled/resampled back the finalOutputResolution before it is passed to the output device.

In general, when processing the pseudo-resolution-independent operations, either no resampling is required (bestResolutionForImageOperation and finalOutputResolution are the same), or a resolution much closer to the finalOutputResolution is used compared with requiring the originalImageResolution if it were a resolution-dependent operation.

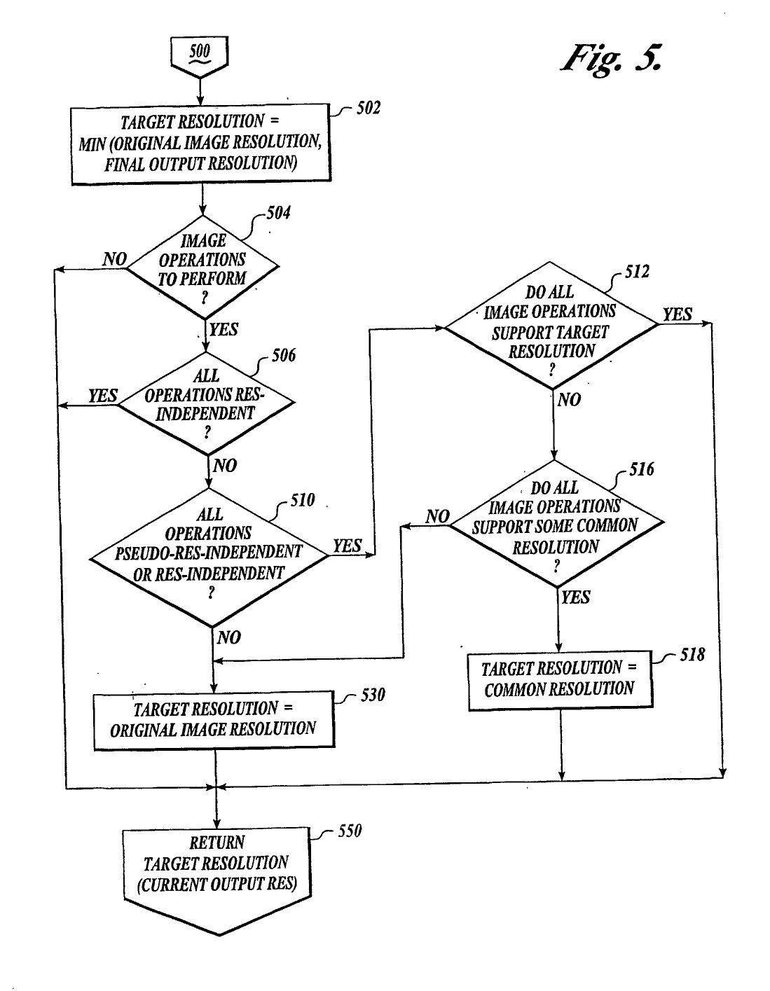

Determination of the initial working resolution (Process 500/FIG. 5) Several different heuristics are applied to determine the ideal resolution for a given image operation (bestResolutionForImageOperation). This value is dependent upon the image operation in question so a general approach is listed below.

A general rule is that it is best not to alter the currentOutputResolution if possible. This preserves image fidelity. Ideally, bestResolutionForImageOperation is the same at the finalOutputResolution such that resampling/rescaling as performed in step 452 of FIG. 4 is not needed. However, this sometimes is not possible.

The next approach is to find a resolution that is consistent and works across all image operations. In this way, at most two resample operations need to be performed: a resample from the originalImageResolution to the targetResolution (for this case, it is the same for all operations) and a final resample to the finalOutputResolution required by the output device. If all image operations can work at the same resolution, no additional resampling is needed. Process 500 and 700 take these rules and approaches into account during its computation.

It is a design goal of the pseudo-resolution-independent image operations to support resolution-independence for a specific discrete set of resolutions provided the continuous range model is not feasible. In the preferred embodiment, this discrete set is the same for all psuedo-resolution-independent operations. In this way, it reduces the amount of resampling required. Even if this is not possible, the pseudo-resolution-independent image operations are still preferred over resolution-dependent operations since rendering usually does not need to occur at the originalImageResolution

Now referring to FIG. 5, process 500 is shown that details the process of selecting the single best resolution for the series of image operations that are to be processed, based on originalImageResolution and the finalOutputResolution. Technically, this process is optional. One implementation of process 500 would be to simply return finalOutputResolution as “single best resolution”. This is valid since process 700 results in the resize of the image to meet the needs of the specific image operation(s).

However, it is advantageous to limit the amount of resampling that occurs, since it results in image degradation. A more desirable approach is to opportunistically find the single best image size for all image operations that are being performed. This may not always be possible, but in the preferred embodiment an attempt is made to find the best initial resolution.

The process 500 begins at 502 where targetResolution is set to the smaller of originalImageResolution and finalOutputResolution. The assumption is that when performing operations at less than the originalImageResolution, it is ok to perform the operations at the finalOutputResolution. This is because the operations are assumed to be resolution-independent or pseudo-resolution independent and result in consistent output, even though it is processed at finalOutputResolution, opposed to the originalImageResolution. However, if the operation is performed at greater than the originalImageResolution, it is acceptable to perform it on the originalImageResolution. This is a performance/memory tradeoff since it is assumed that for this case, performing the operations at the originalImageResolution and then resampling the image to match the finalOutputResolution is acceptable. For some systems and operations this may not be desirable and in those embodiments, the targetResolution is set to finalOutputResolution at 502 (see section 4.1 on High Resolution Processing).

At 504, a determination is made if any image editing operations should be performed. If no image operations are to be performed, then control is passed to 550. Otherwise, at 506 it is determined if all image editing operations are of type resolution-independent. If true, then control is pass to 550. Otherwise, control is passed to 510.

At 510, it is determined if all image operations are of type pseudo-resolution-independent or resolution-independent. If false, control is passed to 530. Otherwise, at 512, it is determined if all operations support the targetResolution. If true, control is pass to 550. Otherwise, control is passed to 516.

At 516, it is determined if all the pseudo-resolution-independent image operations support some “common resolution” closest to the targetResolution. By examining each operation, it is determined if one resolution, which is closest to the targetResolution, is supported. If this is true, then control is pass to 518 where the targetResolution is set to this “common resolution” and control is passed to 550. Otherwise, control is passed to 530.

At 530, either no common resolution has been determined or the operation is resolution-dependent. Therefore, the targetResolution is set to originalImageResolution so processing can be performed on the original image resolution, thus guaranteeing consistent results across all resolutions. Control is then passed to 550.

In the preferred embodiment, step 530 does not occur since some common targetResolution, close to the finalOutputResolution, is always determined for all supported imaging operations in the PictureIQ imaging system. If this were not the case, the pseudo-resolution-independent operation would be treated the same as resolution-dependent operations. In the future, additional work will be done, such as reordering of operations so that those operations that are resolution-independent or are pseudo-resolution-independent and with a resolution close to the finalOutputResolution will be performed first.

At 550, the targetResolution is returned to the caller.

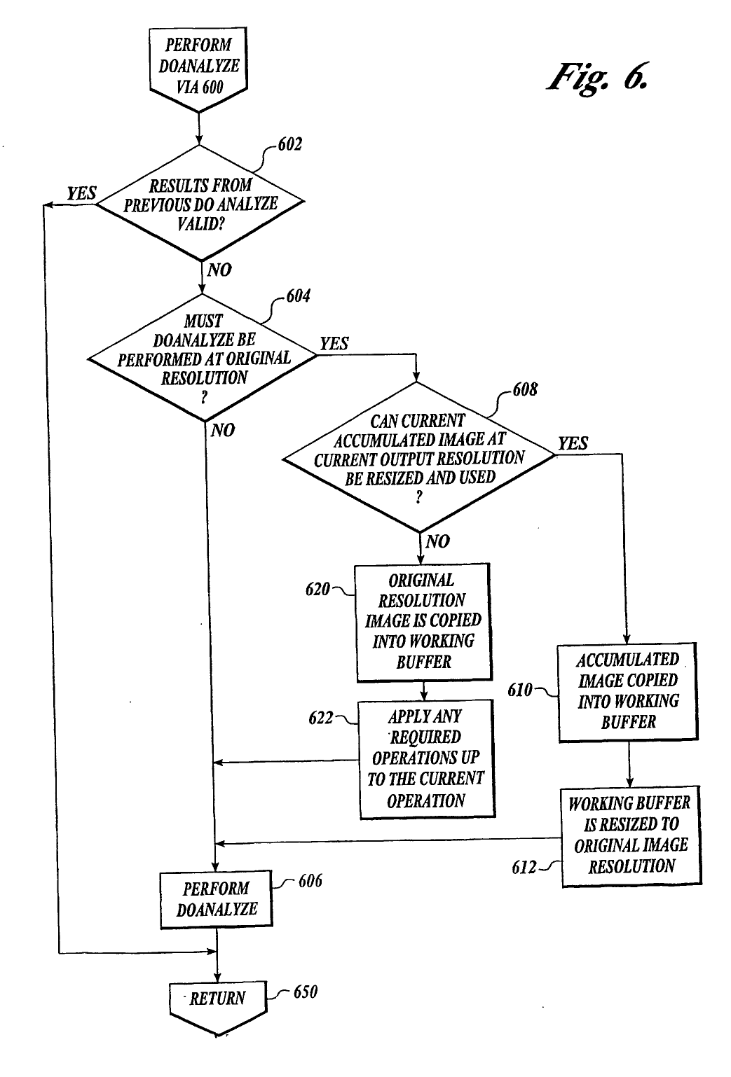

Handle DoAnalyze Phase (Process 600/FIG. 6)

Now referring to FIG. 6, a flowchart is shown detailing the process for handling the DoAnalyze phase as defined by this invention. The process 600 begins at 602 where it is determined if results from a previous DoAnalyze phase exists and are still valid. If this is true, control is passed to 650. Otherwise, at 604, it is determined if the DoAnalyze can be performed at the currentOutputResolution. If this is true, at 606 the DoAnalyze is performed at the currentOutputResolution and control is passed to 650. If this is not the case, the DoAnalyze must be performed at the originalImageResolution at 608.

At 608, it is determined if it is sufficient to resize the accumulated results at the currentOutputResolution to the originalImageResolution, or if all image operations must be reapplied to the original image at the originalImageResolution. If reprocessing of all operations at the originalImageResolution is required, control is passed to 620. Otherwise, at 610 the working image is copied into a separate buffer. At 612, the working image is resized to the originalImageResolution. Control is then passed to 606, where the DoAnalyze is performed.

At 620, the original image at the originalImageResolution is retrieved. At 622, it is determined, based on the current image operation needing the DoAnalyze data, which operations in the sequence up to this operation are to be applied at the original resolution. This may vary depending on the operation. After the original resolution image has been processed, control is then passed to 606, where the DoAnalyze is performed.

At 650, the DoAnalyze phase is complete and all internal variables are persisted/saved. Control is then returned to the caller.

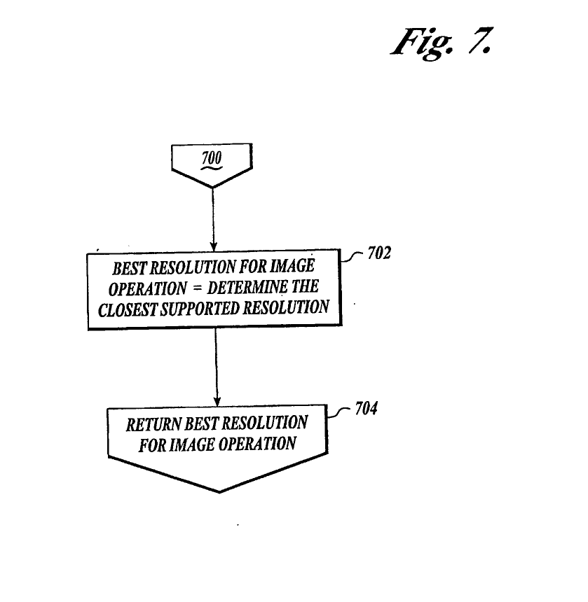

Determine closest supported resolution (Process 700/FIG. 7) Now referring to FIG. 7, process 700 is shown detailing the process of selecting the best resolution (bestResolutionForImageOperation) for a given image operations that is being processed, based on originalImageResolution and the currentOutputResolution. Process 700 starts at 702 where the closest supported resolution for the current image operation compared to the currentOutputResolution is determined and bestResolutionForImageOperation is set to this value.

Unable to find a consistent resolution for all operations. In the preferred embodiment, it is always possible to find a close resolution, generally much smaller than the originalImageResolution that is supported by all pseudo-resolution-dependent operations. By definition, all PictureIQ image operations fall into this category.

In some embodiments, this might not be possible. When this occurs, the originalImageResolution can be used. However, it is generally not desirable to resample the image each time an operation is applied since this results in image degradation.

In another embodiment, if there are two or three common required resolutions needed for all image operations, it may be desirable to support each, with the overhead of additional resample operations to scale between the various operations as needed. This is an application specific tradeoff that must be made based on the ability to re-order the operations.

Handling of Resolution-Dependent Image Operations

While it is true that the maximum benefit of this invention is realized when the image operations utilized are either resolution-independent or pseudo-resolution-independent, other benefits are still possible. For example, it may be possible to re-order the image operations such that the resolution-dependent operations can be performed later (or ideally last) in the sequence of all image operations that are to be performed.

By doing this, many of the image operations that are either resolution-independent or pseudo-resolution-independent can be performed at a lower resolution, ideally at or close to the finalOutputResolution. After those operations have been performed quickly at the finalOutputResolution, the image must be resampled to the originalImageResolution for processing of the resolution-dependent operations. Finally, the image must then be resampled back to the finalOutputResolution. It is application dependent if the potential quality loss or the extra time/resources needed for the resample operations incurred is worth the tradeoff.

While the most significant benefit of this invention is the ability to perform an image operation on much lower resolution image data, other benefits are realized when processing higher resolution image data compared to the original.

Generally, most applications apply the image operations at the original image resolution and resize the image accordingly, smaller or larger, to match the output device. When outputting to a high-resolution print device, the resolution of the printer is generally much higher than that of the original image resolution. In this case, the original image with all the operations applied is resized/resampled to a larger resolution to match the printer.

The drawback with this approach is that resampling to a larger resolution introduces other artifacts, including pixelation (blockiness) and other aliasing effects. This is because higher resolution image data must be “created” since it does not already exist. To circumvent this problem, high frequencies of the image (where pixelation is most prevalent) is slightly blurred to lessen the effects of the aliasing.

If an image processing operation is performed that attenuates the edges (such as a sharpen operation or accented edges), the resample operation may have the effect of either introducing blockiness or a degree of blurring. Each of these is not desirable.

An alternative approach, made possible by this invention, is to first resample the image to match the resolution of the output device, without apply any image operations. Next the various resolution-independent or pseudo-resolution-independent operations are performed at the high-resolution (presumable higher than the original image resolution). This is not possible for any operation that is resolution-dependent since it would result in inconsistent results.

In general, care must be taken if this approach is used. This increases the processing time, and memory requirements, of each image processing operation since they are performed on very high-resolution image data. Further, if any operations are resolution-dependent, they must be performed at the original image resolution

The more likely scenario is to use a hybrid approach that results in processing some of image operations at the original image resolution including all resolution-dependent operations. Then the image is resampled and the subset of resolution-independent or pseudo-resolution-independent operations that exhibit undesirable artifacts as a result of the resample/resize operation is performed at the higher resolution. This assumes that some operations can be reordered.

This invention has been designed to provide consistent results across all resolution. As stated earlier, for image A, an imaging operation is applied to an image at a particular resolution and then the image is resized to a smaller resolution. For image B. the image is first resized to the smaller resolution and then the image operation is applied. If image A and image B are sufficiently close, taking into account the errors introduced during the resampling/resize operation, the operation is considered resolution-independent. Put another way, when the user views image A and image B side by side, they should visually appear the same.

While in theory, if this assumption holds, the affects of resolution-independence are achieved. For some limited set of resolution-independent or pseudo-resolution-independent operations, this may not be entirely correct. Certain artistic effects exhibit this characteristic. When the effect is applied to the original resolution image, it is visible. However, when the original resolution image, with the effect already applied, is resampled to a screen nail or thumbnail, it becomes less visible or not visible at all.

From an image-processing standpoint, the effect of resampling the image down to a smaller resolution reduces the effects of the image processing operation. For example, if a sharpen operation is applied at the original resolution and then the result is resampled to a smaller resolution, the amount of sharpen appears less at lower resolutions. This is because the resample operation tends to blur sharp edges and reduces the effect of the sharpen operation.

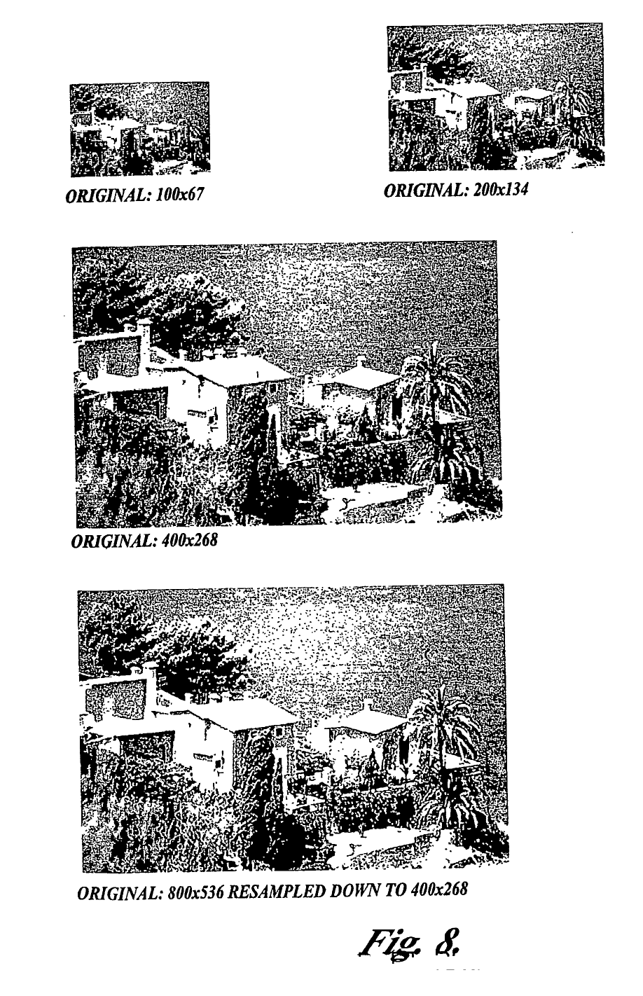

This section presents output that shows the results from using resolution-independent techniques when performing the same operation on several different resolutions, both from resolution-dependent and pseudo-resolufion-independent operations. FIG. 8 shows the original image at different resolutions.

Each section shows four resolutions: 100×67, 200×134, 400×286, and 800×536. The operations are applied at each resolution. Note, the 800×536 image has the operation applied at that resolution and is subsequently resampled down to fit into this document. This allows for direct comparison between the 800×536 and 400×286 resolution. In theory, a pure resolution-independent operation should yield identical results when output is compared side-by-side at the same view size.

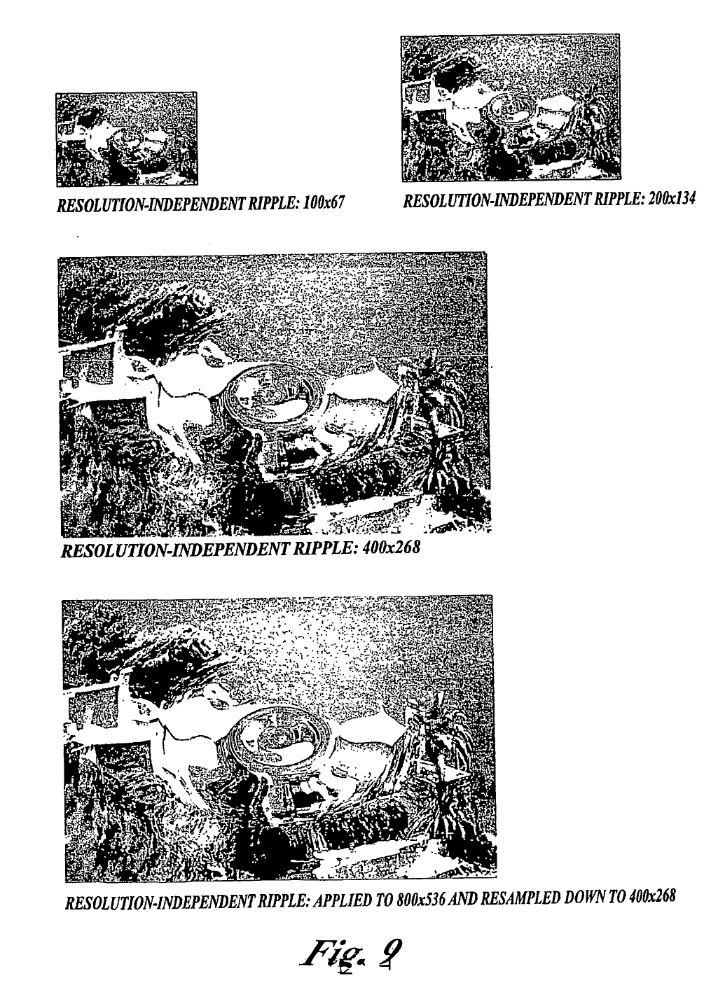

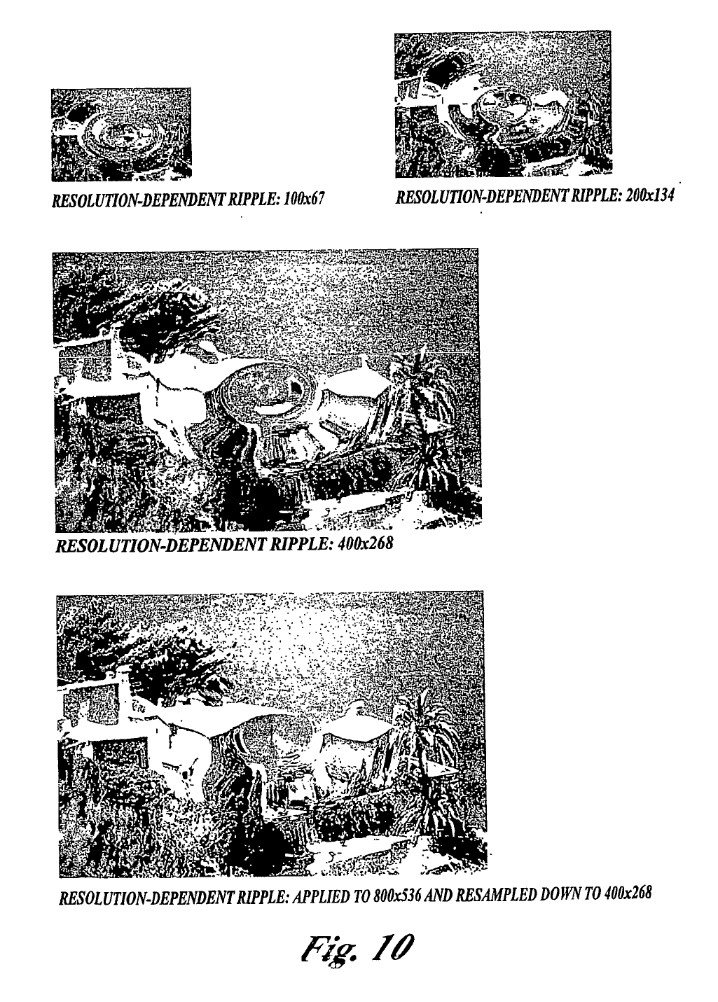

FIGS. 9 and 10 show the output for the ripple filter for a pseudo-resolution-independent version and a resolution-dependent version of the same filter. Notice how the appearance of the ripple effect changes with the resolution in figures shown for the resolution-dependent output. This is an example of a filter in which internal parameters to the algorithm are modified based on the resolution.

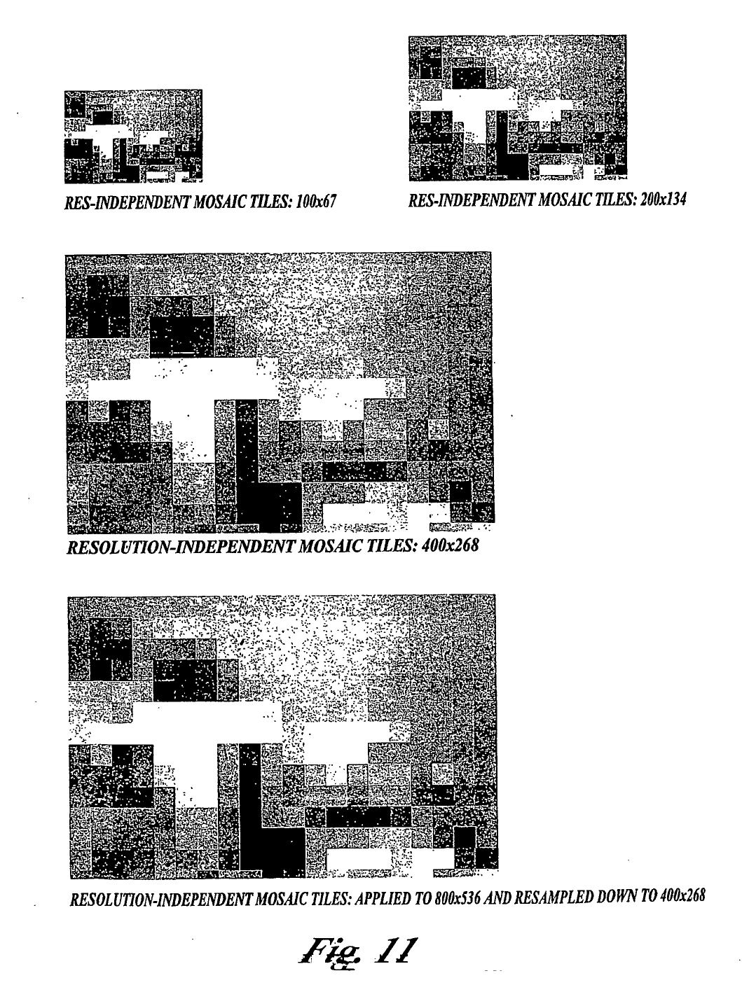

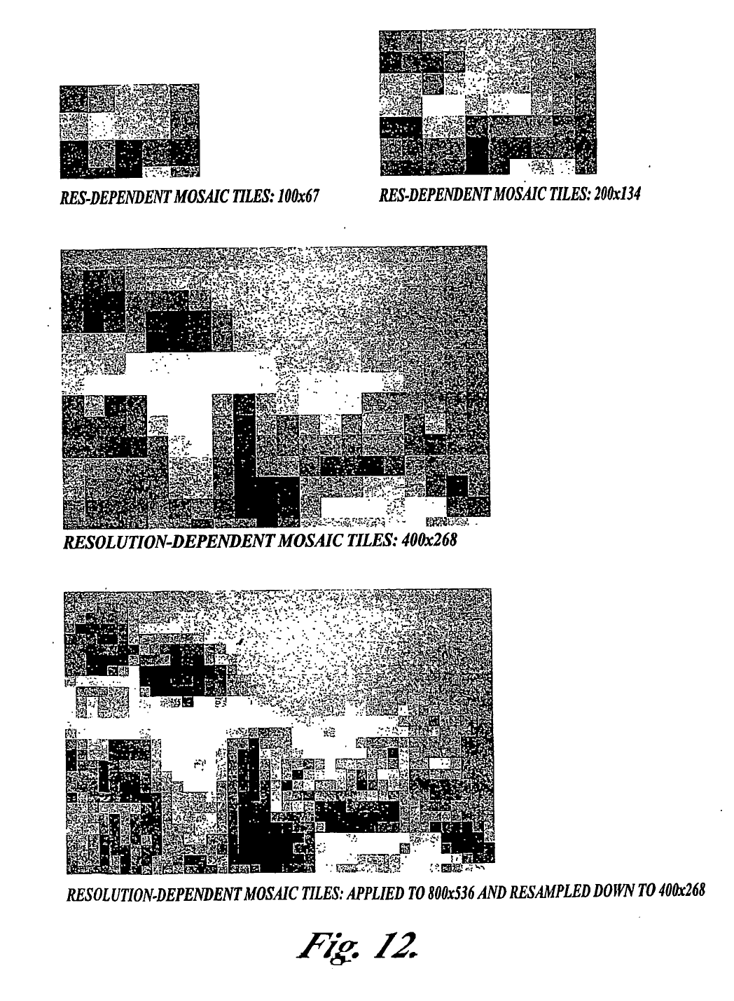

FIGS. 11 and 12 show the output for the mosaic tiles filter for both versions. Notice how the number of tiles changes based on the resolution in the figures shown for the resolution-dependent output. This is an example in which the internal parameters to the algorithm are modified based on the resolution.

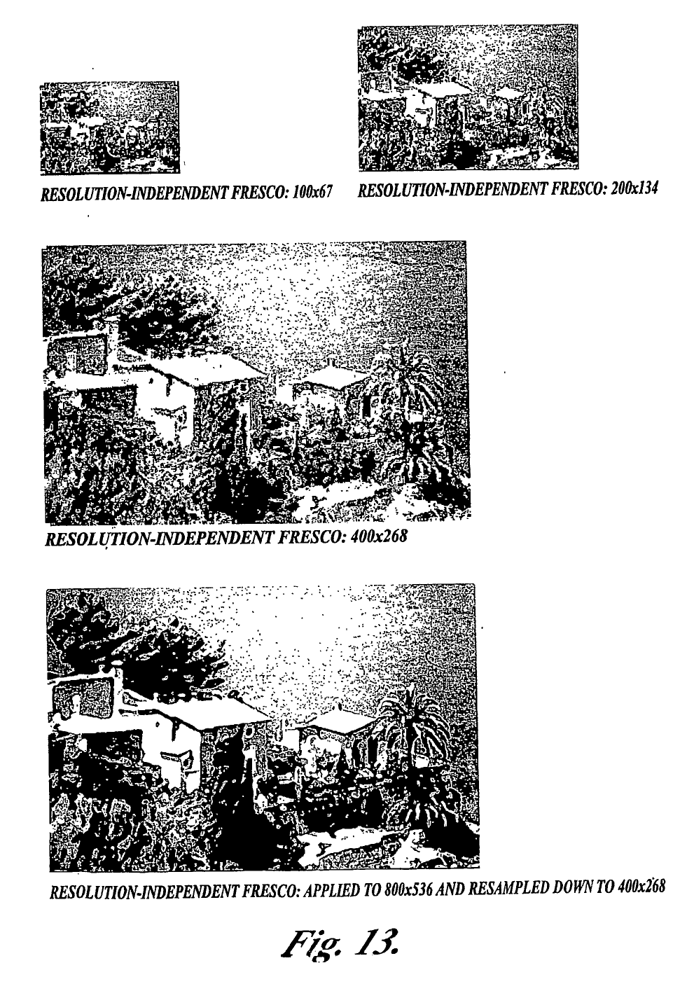

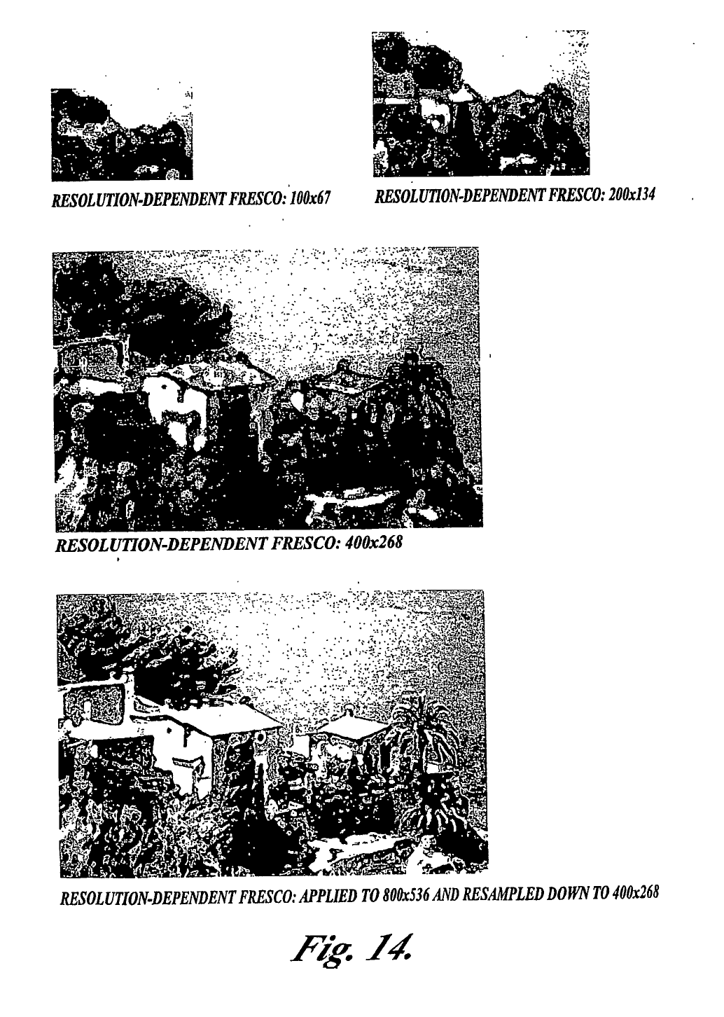

FIGS. 13 and 14 show the output for the Fresco paint effect. Notice the significant difference between the various resolutions for the resolution-dependent output. This is an example in which a discrete set of resolutions is supported. To the keen eye, some differences may be seen between different resolutions of the figures shown for the resolution-independent output, but still very similar. Clearly, this is much better than the resolution-dependent output.

It is important to note, if an application using today's technology (without this invention) wants to achieve the same results across all resolutions, the processing must be performed at the original image resolution. For the Fresco effect, the original image at 1600×1072 takes 11 seconds to complete processing on that resolution running on a 750 MHz Intel Pentium III, in comparison to less than 1 second for the same rendering of a 400×286 or smaller image using pseudo-resolution-independent techniques.

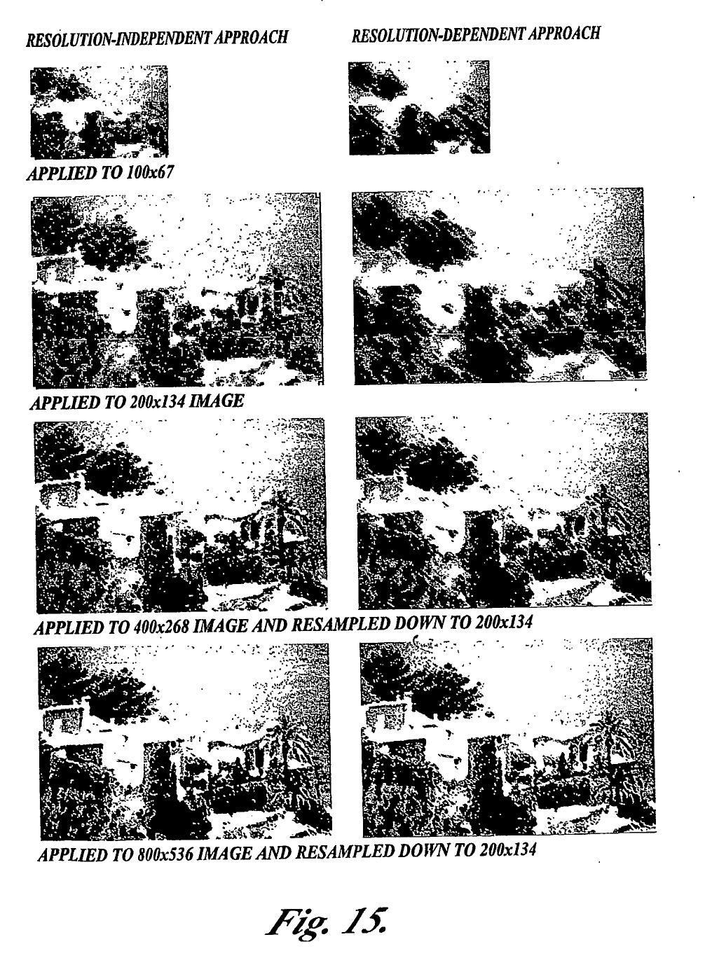

FIG. 15 shows side-by-side results from the output for the Chalk/Charcoal paint effect using pseudo-resolution-independent and resolution-independent techniques. This is an example in which a discrete set of resolutions is supported. For comparisons, it is sometimes helpful to view the same sized output side-by-side since these techniques try to approximate the same results across all resolutions. The best way for the comparison, at the pixel level, is to view each image at the same size, regardless of resolution.

The comparison shows how the different resolutions compare when viewed at the same size. In this case, the 200×134 is viewed at 100%, but the 400×268 is viewed at 50% and the 800×536 is viewed at 25%. When viewed this way, a more accurate determination can be made about how close the resolutions compare side-by-side.

For Chalk/Charcoal, more differences are visible between resolutions using the pseudo-resolution-independent technique. The primary reason for this is due to the fact that when working at lower-resolutions, a certain amount of data is already lost and must be approximated. The same situation exists for a high-resolution photo that is resampled down to a screen nail (320×240) and then enlarged (zoomed in) for comparison with the original. Clearly, there is data loss similar to what is shown in the figures in section 5.8. This should be expected. It is just that certain image operations can perform better at lower-resolutions and are able to “better create” this resolution.

While the present invention has been described as being used with a digital image system (video or still), it should be appreciated that the present invention may generally be implemented on any suitable digital image system. This includes a PC-based imaging application, Web sharing applications that permit sharing, distribution, or viewing of image data between a central server and a client, as well as direct enduser peer-to-peer connected systems.

It can be included as part of an embedded information appliance or digital image device and can work equally well in both a wired network environment as well as a wireless environment.

This disclosure of a system and method to render image data to simulate pseudo-resolution-independent behavior according to the preferred embodiments of the present invention is merely exemplary in nature and is no way intended to limit the invention or its application or uses. Further, in the above description, numerous specific details for implementation are set forth to provide a more thorough understanding of the present invention disclosure. It will be apparent, however, to one skilled in the art, that the present invention may be practiced without these specific details. In other instances, characteristics and functions of the well known processes have not been described so as not to obscure the present invention.

We claim:

1. A method for applying normally resolution-dependent image effects to a digital image in such a manner as to enable a rendering of said digital image at any resulting resolution while substantially maintaining the appearance of the image effect, comprising the steps of:
a. determining what imaging effect parameters will substantially modify the imaging effect results when rendered at a different resolution; and
b. modifying said parameters to account for the resultant rendering resolution.

2. The method of claim 1 wherein the imaging effect is based on the transform function derived from a histogram of the image and further including the steps of:
a. analyzing pixel data of the image at an original resolution; and
b. determining the appropriate image operation parameters; and
c. modifying said parameters subordinate to a predetermined resulting resolution.

3. The method of claim 1 wherein the imaging effect is based upon a coordinate and radius of particular area of a digital image and further including the steps of:
a. preserving coordinate and radius data in terms relative to the original resolution; and
b. performing the desired imaging effect at a resulting resolution with the radius and coordinate information modified by that resulting resolution.

4. The method of claim 3 wherein the imaging effect is red-eye reduction.

5. The method of claim 1 wherein the imaging effect is an artificial lighting adjustment further including:
a. a spectral analysis of quantity of each range of light frequency in the image and determining that quantity in terms of a percentage; and
b. applying an imaging effect using that percentage; and
c. upon rendering the image at any resolution, that determined percentage of light is kept substantially constant.

6. The method of claim 1 wherein the imaging effect is based on a value dependent upon determining an image resolution and further including the step of scaling that dependent value, based on the resulting resolution required.

7. The method of claim 1 wherein the imaging effect is based on different discrete internal parameter values, thereby requiring the selection of a subset of appropriate values dependent on the resulting resolution required.

8. A method for applying techniques to the resolution dependent characteristics of a digital image comprising the steps of:
a. opening the image;
b. determining the image resolution;
c. determining an output device resolution;
d. selecting an optimal resolution upon which to apply an image effect; and
e. applying the image effect to the optimal resolution selected.
